(19) United States
(12) Patent Application Publication
(10) Pub. No.: US 2013/0084838 A1
(43) Pub. Date: Apr. 4, 2013

(54) System, method, and apparatus for viewing underground structures

(71) Applicant: Geospatial Holdings, Inc., Sarver, PA (US)

(72) Inventors: Mark A. Smith, Natrona Heights, PA (US); George L. Brandt, Bethel Park, PA (US); Christopher D. Carlin, Sewickley, PA (US)

(73) Assignee: Geospatial Holdings, Inc., Sarver, PA (US)

(21) Appl. No.: 13/573,712

(22) Filed: Oct. 3, 2012

Related U.S. Application Data
(60) Provisional application No. 61/542,467, filed on Oct. 3, 2011.

(51) Int. Cl. H04W 64/00

(52) U.S. Cl. 455/414.2

(57) ABSTRACT

A system, method, and apparatus for displaying underground structures that include at least one processor, at least one display device, and at least one computer-readable medium comprising program instructions that, when executed by the at least one processor, cause the mobile device to determine a location of the mobile device, determine an area to be displayed based at least partially on the location of the mobile device, identify underground structure data for the area to be displayed, and generate, on or with the at least one display device, a graphical representation of the area including the at least one underground structure. Systems, methods, and apparatus are also provided to provide underground structure data to a mobile device based on a location of the mobile device.

### CROSS REFERENCE TO RELATED APPLICATIONS

This application claims benefit of priority from U.S. Provisional Patent Application No. 61/542,467, filed Oct. 3, 2011, which is incorporated by reference in its entirety.

### BACKGROUND OF THE INVENTION

1. Field of the Invention

This invention relates generally to a system for viewing underground structures and, more specifically, a system, method, and apparatus for visualizing underground structures on a device, such as a mobile device.

2. Background of the Invention

Current industry practices utilize traditional engineering data collection and management activities, such as “as-built” installation documentation, engineering surveys, and geographic information systems (GIS) for information gathering and retrieval. However, the stakeholders associated with an underground asset (e.g., underground structure) are in need of more efficient methods to gather, manipulate, and retrieve accurate data related to the efficient management of the asset.

Moreover, current systems in use do not provide location, identification, viewing, and management tools for maintenance and/or survey personnel to use in the field. Thus, field personnel lack adequate tools to locate and/or document underground structures, and often have to use several other systems and/or methods to record inspection information, create reports, and the like. Thus, there is a need for systems, methods, and apparatus to view underground structures on various devices, such as mobile devices used in the field.

### SUMMARY OF THE INVENTION

Therefore, it is an object of the present invention to provide a system, method, and apparatus for viewing underground structures that address or overcome certain drawbacks and deficiencies in existing viewing and/or management systems. Preferably, the present invention provides systems, methods, and apparatus for viewing underground structures on a mobile device based on a location and/or orientation of the mobile device.

According to one preferred and non-limiting embodiment of the present invention, provided is a mobile device for displaying underground structures, the mobile device comprising at least one processor; at least one display device; at least one computer-readable medium comprising program instructions that, when executed by the at least one processor, cause the mobile device to: determine a location of the mobile device; determine an area to be displayed based at least partially on the location of the mobile device; identify underground structure data for the area to be displayed, the underground structure data representing a location of at least a portion of at least one underground structure; and generate, on or with the at least one display device, a graphical representation of the area including the at least one underground structure.

According to another preferred and non-limiting embodiment, provided is a computer-implemented method for displaying underground structures on a mobile device including at least one processor, the method comprising: generating, on the mobile device, a display of an area based at least partially on a location of the mobile device; receiving underground structure data for the location of the mobile device; and generating, on the display of the area, at least one underground structure based at least partially on the location and the underground structure data.

According to a further preferred and non-limiting embodiment of the present invention, provided is a system for displaying underground structures on a mobile device, the system comprising: at least one underground structure database comprising underground structure data; at least one server computer configured to: receive location data from a mobile device, the location data based at least partially on a physical location of the mobile device; transmit, to the mobile device, at least a first portion of the underground structure data based at least partially on the location data; receive updated location data from the mobile device, the updated location data based at least partially on a second physical location of the mobile device; and transmit, to the mobile device, at least a second portion of the underground structure data based at least partially on the updated location data.

According to yet another preferred and non-limiting embodiment of the present invention, provided is a computer-implemented method for displaying underground structures on a mobile device, the method comprising: receiving location data from a mobile device, the location data based at least partially on a physical location of the mobile device; transmitting, to the mobile device, at least a first portion of the underground structure data based at least partially on the location data; receiving updated location data from the mobile device, the updated location data based at least partially on a second physical location of the mobile device; and transmitting, to the mobile device, at least a second portion of the underground structure data based at least partially on the updated location data.

According to a further preferred and non-limiting embodiment of the present invention, provided is a non-transitory machine-readable medium comprising program instructions that, when executed by at least one mobile device including at least one processor, cause the mobile device to: determine a location and an orientation of a mobile device; generate a display on the mobile device based at least partially on the orientation and the location of the mobile device, the display comprising at least one of the following: a map, a satellite image, a camera image, a rendering, a two-dimensional rendering, a three-dimensional rendering, or any combination thereof; receive underground structure data for the location of the mobile device from at least one of the following: a remote underground structure database, a local underground structure database, a buried underground structure data source, or any combination thereof; and generate, in combination with the display, a visual representation of at least one underground structure based at least partially on the underground structure data.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of an underground structure viewing system according to the principles of the present invention;

FIG. 2 is another schematic view of one embodiment of an underground structure viewing system according to the principles of the present invention;

FIG. 3 is a view of a graphical user interface of an underground structure viewing system according to the principles of the present invention;

FIG. 4 is another view of a graphical user interface of an underground structure viewing system according to the principles of the present invention;

FIG. 5 is a view of a graphical user interface of an underground structure viewing system with a selection menu according to the principles of the present invention;

FIG. 6 is a view of a graphical user interface of an underground structure viewing system with directional instructions to an underground structure according to the principles of the present invention;

FIG. 7 is a view of a graphical user interface of an underground structure viewing system with an alert indicator and status message according to the principles of the present invention;

FIG. 8 is a view of a graphical user interface of an underground structure viewing system with a display box of underground structure data for an underground structure according to the principles of the present invention;

FIG. 9 is a view of a graphical user interface of an underground structure viewing system with a data entry display according to the principles of the present invention;

FIG. 10 is a view of a graphical user interface of an underground structure viewing system with an authentication entry display according to the principles of the present invention;

FIG. 11A is a view of a graphical user interface of an underground structure viewing system with a three-dimensional rendering of an area and underground structures according to the principles of the present invention;

FIG. 11B is a further view of the graphical user interface shown in FIG. 11A;

FIG. 12 is a step diagram for one embodiment of an underground structure viewing system and method according to the principles of the present invention;

FIG. 13 is a step diagram for another embodiment of an underground structure viewing system and method according to the principles of the present invention; and

FIG. 14 is a view of a schematic diagram of a computer and network infrastructure according to the prior art.

### DETAILED DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, and/or routed between the first and second unit or component. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible.

In one preferred and non-limiting embodiment of the present invention, an underground structure viewing system allows users, such as but not limited to maintenance and/or survey personnel, to view underground structures on a computing device, such as a mobile computing device. The underground structures are visualized based on a location and/or an orientation of the mobile computing device and underground structure data received from one or more remote, local, and/or buried underground structure data sources. The mobile computing device provides one or more graphical user interfaces (GUI) for interacting with the visualized underground structures and/or providing other tools and features for locating, managing, inspecting, and/or identifying various underground structures.

As used herein, the terms “underground structure” and “underground structures” refer to one or more underground objects, resources, and/or assets such as, for example, pipelines, conduits, cables, lines, valves, manholes, culverts, fittings, hydrants, meters, catch basins, curb inlets, lift stations, pump stations, poles, junction boxes, curb boxes, storage tanks, sewers, and other underground natural and/or man-made objects, assets, devices, systems, resources, and/or structures.

The term “underground structure data source”, as used herein, may refer to one or more data structures located remotely and/or locally that contain information, parameters, and/or other data relating to one or more underground structures. Local underground structure data sources may include data sources that are stored in local memory on the mobile device, or buried data sources that are located underground in an area proximate to a related underground structure. As an example, an underground structure data source may include a spatial database representing spatial data, such that the data relates to the location, orientation, and/or depth of one or more underground structures based on spatial coordinate points, lines, polygons, and/or the like. An underground structure data source may also simply provide an identification of one or more underground structures that may be used to retrieve further data from a remote and/or local database.

A data source may also include tabular data containing information and parameters about various underground structures such as, for example, identification, status, use, type, material, size, depth, pressure, structure identification, media, and/or the like. Identification information identifies or indicates the underground structure that is being viewed and/or selected. Status information may indicate that an underground structure is, for example, abandoned, buried, in-service, incomplete, permanent, proposed, retired, and/or the like. Use information may indicate that an underground structure is, for example, used for fire, main, raw water, service, siphon, sprinkler, and/or other functions. Type information may indicate that an underground structure is a particular type or shape (e.g., box, circular, oval, perforated, etc.). Material information may indicate that an underground structure is made of a particular material such as abs, ac, al, armored glass, brick, cast iron, cement, composite, concrete, corrugated steel, di, fiberglass, galvanized, glass-lined, HDPE, metal, nickel, plastic, precast, pre-stressed, PVC, stainless steel, clay, stone, titanium, and/or other materials. Moreover, the underground structure data source may be structured so as to allow for retrieval and/or management of the data through a Structured Query Language (SQL), or other data retrieval or management methods.

The location of underground structures, as specified by the underground structure data or determined by a mobile device, may be determined in any number of ways including, but not limited to, those methods, apparatus, and systems described in U.S. patent application Ser. No. 12/504,854, filed Jul. 17, 2009 (published as United States Publication No. 2010/0030528), U.S. patent application Ser. No. 12/484,586, filed Jun. 15, 2009 (published as United States Publication No. 2009/0312986), and U.S. patent application Ser. No. 12/510,509, filed Jul. 28, 2009 (published as United States Publication No. 2010/0023303), all of which are hereby incorporated by reference in their entirety. In one example, a robotic probe device may be used to navigate one or more underground structures and record coordinate points, physical characteristics, and/or other information relating to the one or more underground structures.

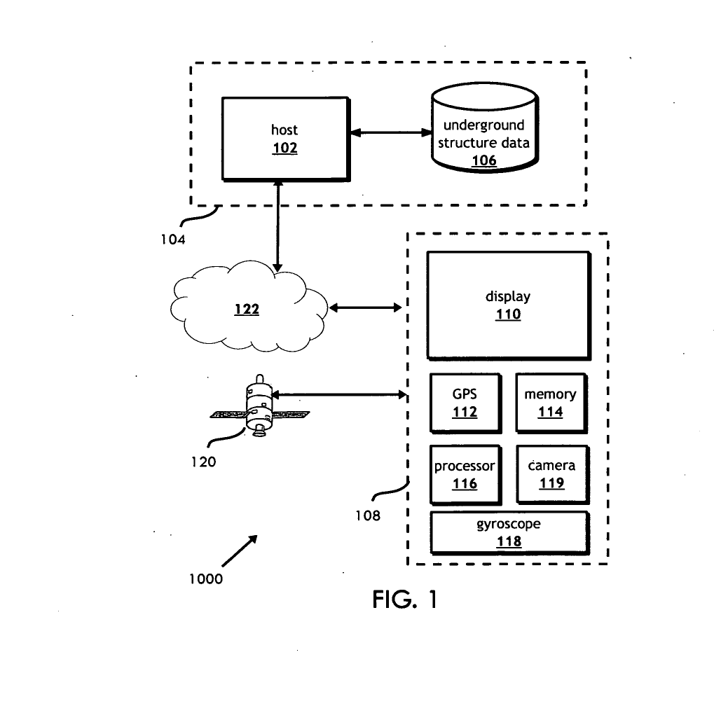

Referring to FIG. 1, an underground structure viewing system 1000 is shown according to one preferred and non-limiting embodiment of the present invention. An underground structure host system 104 includes a host 102 and one or more underground structure data sources 106. The host 102 is in communication with the data source 106 and a network environment 122, such as the interne. A device, such as a mobile device 108, is also in communication with the network environment 122, and includes a display device 110, a Global Positioning System (GPS) device 112, a data storage (e.g., memory) device 114, a processor 116, a gyroscope 118, and a camera unit 119. The display device 110 may be, as an example, a touch screen display that additionally serves as an input device. It will be appreciated that the mobile device 108 may include any number of other devices and/or components such as, for example, accelerometers, compasses, location systems, graphics processors, hard disks, solid state storage devices (e.g., flash memory), input devices, and/or the like. The mobile device 108 is in communication with a GPS satellite 120 or any other system or device for determining a physical location of the mobile device 108 such as, but not limited to, one or more cellular network towers, wireless network connections, and/or the like. A physical location of the mobile device 108 may also be specified by a user through an input device, such as a touch screen, keyboard, mouse, microphone, and/or the like.

With continued reference to FIG. 1, the host 102 may include one or more server computers configured to provide data content to mobile devices 108. In one example, the host 102 is a web server and communicates with the mobile devices 108 through an HTTP connection. However, it will be appreciated that any number of communication protocols and/or methods may be used, and that the host 102 may be directly or indirectly in communication with the mobile device 108. The host 102 may perform all, some, or none of the data processing required to carry out some embodiments, and may share processing capabilities with other devices, including the mobile device 108. In one preferred and non-limiting embodiment, the host 102 receives location and/or orientation information from the mobile device 108 and identifies relevant underground structure data for the location of the mobile device from one or more underground structure data sources 106. The host 102 may then provide the relevant underground structure data to the mobile device 108, or otherwise make it available for retrieval. In other embodiments, the host 102 may receive directed queries for particular underground structure data from the mobile device 108, and allow for the mobile device 108 to retrieve the data it requests from the underground structure data source 106 through SQL or other like methods.

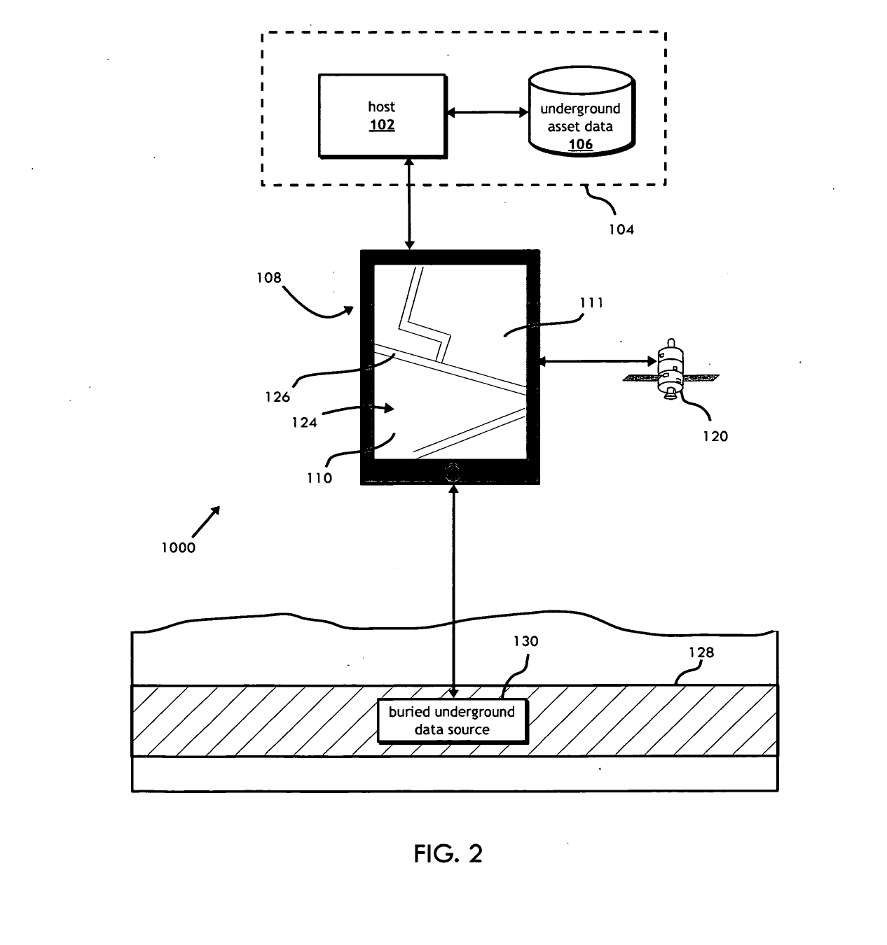

Referring now to FIG. 2, the mobile device 108 generates, on or with the display device 110, a graphical user interface (GUI) 124 including a visualization (e.g., graphical representation) of an area 111 and visualizations of one or more underground structures 126. In addition to or instead of an underground structure data source 106 located remotely and/or locally, the mobile device 108 may receive underground structure data from a buried underground data source 130. In FIG. 2, the buried underground data source 130 is associated with an underground structure 128 and, in one example, may be affixed or otherwise attached to the underground structure 128. The buried underground data source 130 may be, for example, one or more radio frequency identification (RFID) transponders, data transmitters, pipe markers, and/or any other device or system for emitting signals including underground structure data to a network environment and/or the mobile device 108. It will be appreciated that the local underground data source 130 may be affixed or otherwise attached to the underground structure 128 or, in other embodiments, may be data sources separated from but proximate to the underground structure 128.

With reference to FIGS. 2-8, exemplary GUIs 124 are shown according to preferred and non-limiting embodiments. The GUIs 124 may include a graphical representation of an area 111 such as, for example, a map, satellite image, real-time camera image/video, three-dimensional rendering, two-dimensional rendering, and/or the like. The graphical representation of an area 111 may include, but is not limited to, roads, buildings, aboveground structures, underground structures, areas of interest, places of interest, boundary lines, water sources, geological features, geographical features, and/or environmental features. Further, the graphical representation of the area 111 may be generated based on image and/or graphical data retrieved from local image or map data sources, from remote third-party sources such as Google Maps, Google Earth, MapQuest, U.S. Geological Survey (USGS) resources, municipality data, and/or remote data sources 106 provided by the underground structure viewing system 1000.

With continued reference to FIGS. 2-8, it will be appreciated that the GUIs 124 may be generated on the display device 110 by the mobile device 108, the host 102, or any combination of processing devices. For example, the mobile device 108 may receive streaming graphical data from the host 102 based on a location of the mobile device 108, may display graphical data stored locally on the mobile device 108, and/or may display a combination of graphical data stored locally and streamed from a remote source. Further, the mobile device 108 may display real-time image/video data on the display device 110 captured from a camera unit 119 (not shown) that is part of or in communication with the mobile device 108. Moreover, the mobile device 108 may receive graphical data from the host 102 and, based on that data, generate rendered graphical data on the mobile device 108. The mobile device 108 will generate, on the graphical representation of the area 111 being displayed on the GUI 124, visualizations of at least one underground structure 126 (if present).

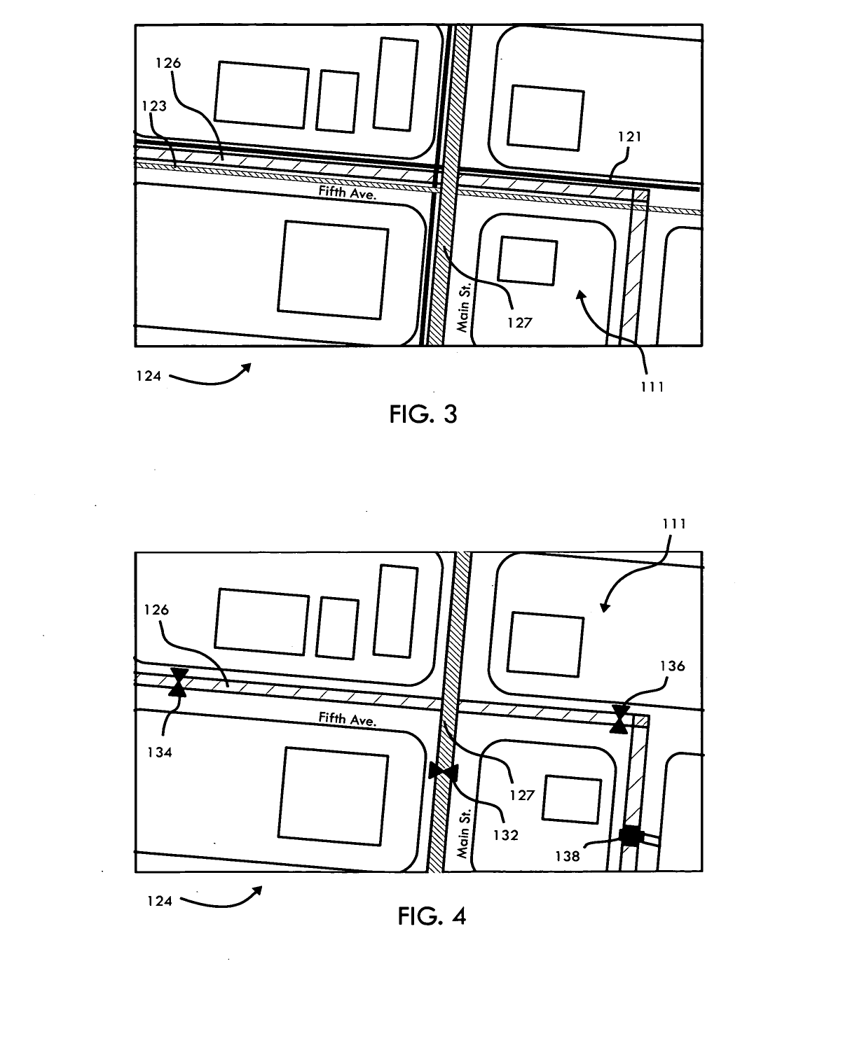

Referring to FIGS. 3-8, the graphical representation of the area 111 displayed within the GUIs 124 includes an aerial-view map. The aerial-view map may be a two-dimensional rendering, static map image data, a satellite image, and/or the like. Further, it will be appreciated that the graphical representation of the area 111 may be computer generated or photographic, as examples.

Referring now to FIG. 3, the GUI 124 depicts different underground structures 121, 123, 126, 127 on a graphical representation of an area 111. The different underground structures 121, 123, 126, 127 may be visualized in various different ways so that they can be differentiated by a user. In one example, the underground structures 121, 123, 126, 127 may be visualized as different colors, textures, and/or sizes to identify and/or differentiate the status, type, material, use, and/or other parameters or attributes of the underground structures. For example, underground structures used for waste water may be green, underground structures used for water may be blue, underground structures used for storm sewer lines may be red, underground structures used for gas may be orange, and underground structures used for electricity may be purple. It will be appreciated that different hatch marks, textures, shapes, sizes, thicknesses, textual labels, and/or shades may be used to distinguish different underground structures.

With reference to FIG. 4, the GUI 124 includes additional underground structures such as valves 132, 134, 136, and fittings 138. These additional underground structures 132, 134, 136, 138 may be represented by any number of shapes, text, and/or icons and may also include, as examples, hydrants, meters, catch basins, curb inlets, lift stations, pump stations, cleanouts, manholes, poles, electrical junction boxes, curb boxes, storage tanks, vents, and other like underground structures and related structures.

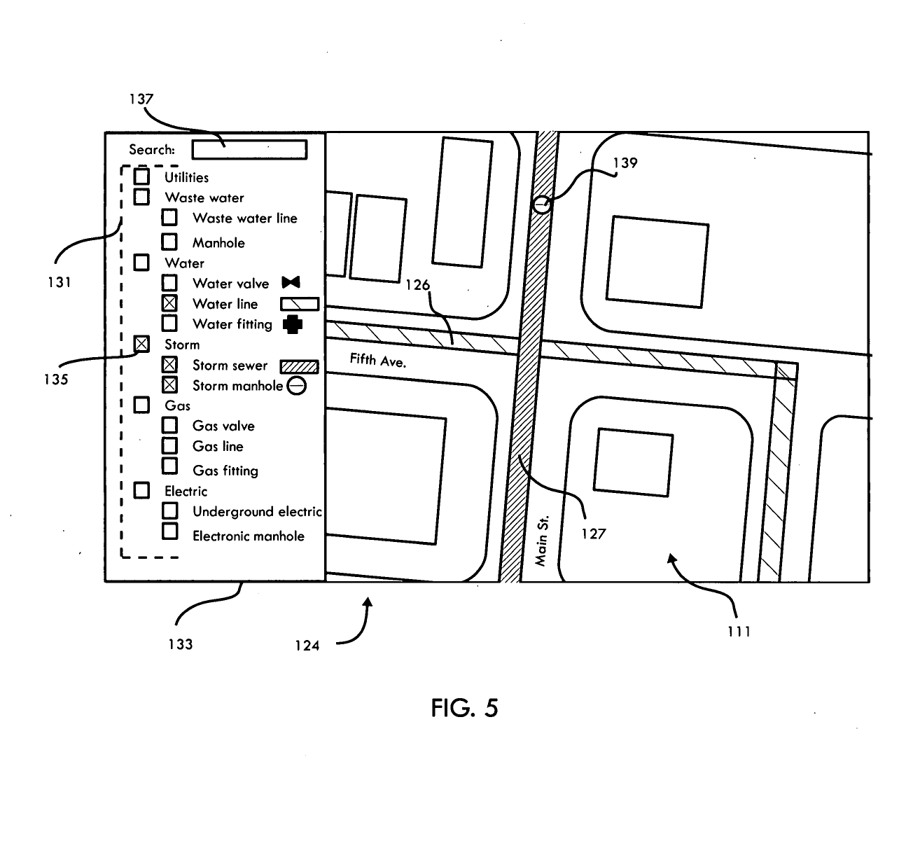

Referring now to FIG. 5, a GUI 124 is displayed including a selection menu 133. The selection menu 133 has a variety of selection options 131 including structure type (e.g., utilities, waste water, water, storm, gas, electric, and the like) checkboxes 135. In this example, selecting one or more structure types controls what underground structures 126, 127, 139 are displayed on the GUI 124 and in combination with the graphical representation of the area 111. In this way, different structure types may be considered differing layers that can be selectively viewed. In FIG. 5, the selection options 131 are arranged hierarchically such that, under each checkbox 135, related options are presented. For example, selecting the checkbox 135 for “Storm” may automatically select the checkboxes for “Storm sewer” and “Storm manhole”. Likewise, selecting the checkbox for “Waste water” may automatically select the checkboxes for “Waste water line” and “Manhole.” Users may also have the option to select “Waste water line” and/or “Manhole” options individually. The selection options 131 may further include legends to identify different underground structures. In the example depicted in FIG. 5, the selection options 131 further include “Utilities”, “Waste”, “Gas”, and “Electric” structure types, including separate options for “Water valve”, “Water line”, and “Water fitting” under the “Water” option, “Gas valve”, “Gas line”, and “Gas fitting” under the “Gas” option, and “Underground electric” and “Electric manhole” under the “Electric” option. It will be appreciated that the selection menu 133 may include a variety of different selection options 131, search capabilities, filtering capabilities, and the like, and may be organized in various ways including, but not limited to, tabular, hierarchical, and node-based structures. Further, it will be appreciated that the selection options 131 may include checkboxes 135, pull-down menus, text inputs, push buttons, radio buttons, hypertext, and/or other interface features. Still further, it is envisioned that the user can identify a specific underground structure or a customized group of underground structures to be viewed.

Still referring to FIG. 5, the GUI 124 may also include one or more search interfaces 137. The search interface 137 may be provided within the selection menu 133, or may be provided by any other screen or interface of the GUI 124. Further, it will be appreciated that a search interface 137 or other search option may be presented upon actuation of a button on the mobile device 108, or through a menu selection system otherwise provided by the mobile device 108. The search interface 137 may be a text input box, as depicted in FIG. 5, or may respond to voice commands. The search interface 137 may be configured to search one or more text fields of the underground structure data such as, for example, name, identification number, type, status, condition, material, history, and/or the like, and identify any relevant underground structures for the search terms. Also, as discussed, specific underground structures or groups of structures may be searched, selected, and/or viewed.

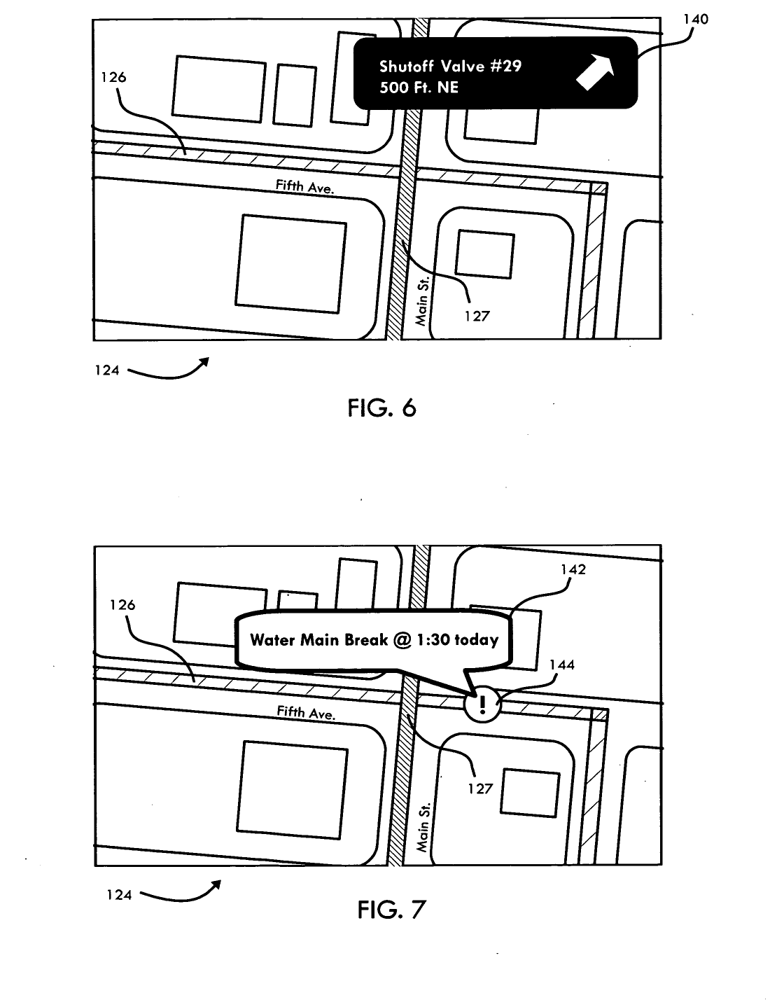

Referring to FIG. 6, a GUI 124 is shown including navigational instructions 140 according to one preferred and non-limiting embodiment of the present invention. In this example, a selected underground structure (e.g., Shutoff Valve #29) is northeast from the physical location of the mobile device 108. The navigational instructions 140 indicate what underground structure is being located, the distance to that underground structure from a physical location of the mobile device 108 (e.g., 500 feet), and a directional arrow indicating what direction a location of the underground structure is in relation to the mobile device 108. The navigational instructions 140 may be used by maintenance personnel and/or surveyors, as examples, to locate various underground structures in the field. After selecting a desired underground structure, the user can follow the navigational instructions 140 to arrive at the underground structure while holding the mobile device 108. The navigational instructions 140 may be generated by the mobile device 108 and/or the host 102 based on the location and/or orientation of the mobile device 108 and the underground structure data. The orientation of the mobile device 108 may be determined by a gyroscope 118, compass, accelerometer, camera unit 119, and/or other devices in communication with the mobile device 108. Further, the location of the mobile device 108 may be determined from user input, GPS data, cellular tower triangulation, wireless networks, and/or other methods. It will be appreciated that the navigational instructions 140 may be visual and/or audible, and may provide directions as a straight line from location to destination, or as walking and/or driving directions that take into consideration streets, walkways, traffic, buildings, obstacles, and/or the like.

Referring now to FIG. 7, a GUI 124 is shown including a status message 142 and an alert indicator 144 according to one preferred and non-limiting embodiment of the present invention. The alert indicator 144 may be any icon, graphic, or indication on the GUI 124. Touching, clicking, or otherwise selecting the alert indicator 144 may display a status message 142 including status information for a particular underground structure 126. In the illustrated example, the alert indicator 144 indicates that a water main broke at a particular time. The alert indicator 144 and/or the status message 142 may be generated by the mobile device 108 and/or the host 102. Further, the alert indicator 144 and/or the status message 142 may be generated based on underground structure data. It will be appreciated that status messages may be generated in any number of ways, and may be visually represented in any number of ways. Further, alert indicators 144 and/or status messages 142 may be provided audibly as well as visually. Alert indicators 144 and/or status messages 142 may be associated with navigational instructions 140 (as shown in FIG. 6), such that underground structures related to the alert indicators 144 and/or status messages 142 may be located and navigated to.

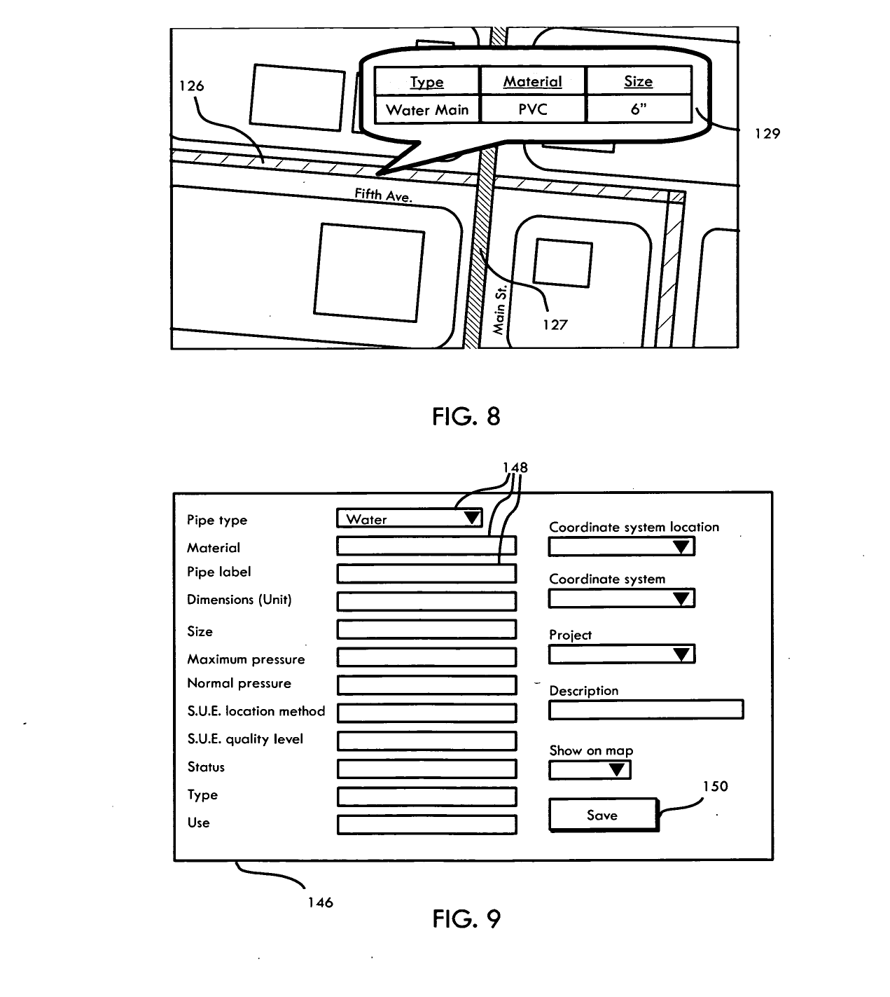

With reference to FIG. 8, a GUI 124 is shown including a display box 129 of underground structure data according to one preferred and non-limiting embodiment of the present invention. The display box 129 in this example includes the type, material, and size of a particular underground structure 126. However, it will be appreciated that underground structure data may be displayed in any number of ways. A display box 129 may be displayed in response to an underground structure 126 being selected by touching, clicking, and/or otherwise indicating a particular underground structure 126 shown on the GUI 124, listed in a search result, or otherwise provided. Moreover, the underground structure data for a selected underground structure may also be provided audibly to a user.

In one preferred and non-limiting embodiment of the present invention, various management tools are provided on the mobile device 108 to allow at least a portion of the underground structure data to be entered, deleted, edited, and/or otherwise modified. For example, information may be inputted to the mobile device 108 by typing, speaking, and/or selecting various options. The inputted information may be stored in local memory 114 on the mobile device 108, stored in buried data sources 130, and/or stored in a remote data source 106, as examples. In one example, an underground structure that is deleted by a user may not necessarily be deleted but, rather, flagged as being deleted or otherwise irrelevant in a database. However, in other embodiments, an underground structure may also be deleted permanently from the underground structure data. As will be discussed herein, the authority to delete, enter, edit, or otherwise modify underground structure data may be set forth by user credentials.

Referring to FIG. 9, an underground structure data entry display 146 is shown according to one preferred and non-limiting embodiment of the present invention. The data entry display 146 may be used to add new underground structures or modify underground structure data for underground structures that are already represented by the underground structure data. The data entry display 146 includes a variety of data fields 148 that may include text boxes, pull-down menus, and/or other selection options such as radio buttons, checkboxes, and/or the like. A Save button 150 saves the data entered into the data entry display 146 in a local, remote, and/or buried data source. In FIG. 9, the data fields 148 represent “Pipe type”, “Material”, “Pipe label”, “Dimensions”, “Size”, “Maximum pressure”, “Normal pressure”, “Subsurface utility engineering (S.U.E.) quality level”, “S.U.E. location method”, “Status”, “Type”, “Use”, “Coordinate system location”, “Coordinate system”, “Project”, “Description”, and “Show on map”. However, it will be appreciated that any number of different data fields may be available. Further, a user of the mobile device 108 may enter data into the data entry display 146 by selection from a list or menu, text input, voice commands, and/or the like.

In one preferred and non-limiting embodiment of the present invention, users of the mobile device 108 may associate media content with an underground structure and/or an area at or around the underground structure, e.g., aboveground items/structures, underground items/structures, and the like. For example, associated media content may include documents, photographs, videos, audio files, and/or the like. The media content may be created on or with the mobile device 108, and may also be created on or with other devices. A built-in camera unit 119, microphone, or external device of the mobile device may be used by maintenance personnel and/or surveyors to create media content related to one or more underground structures. The media content may be stored on the mobile device 108, in a remote data source, and/or in a buried data source 130, as examples. Pointers or links may be used to associate a storage location of the media content with the underground structure data for a particular underground structure. Media content associated with underground structures may also be displayed on the mobile device 108, and icons or other indicators may be displayed on a GUI 124 to link to the media content.

Referring again to FIG. 9, in one preferred and non-limiting embodiment of the present invention, users of the mobile device 108 may use the data entry display 146 or other like data entry interfaces to record actions and/or events for a particular underground structure. For example, a history of an underground structure may be stored in an underground structure data source based on user input with regard to maintenance, installments, inspections, conditions, performance, and/or other like attributes, parameters, or events. Maintenance and/or survey field personnel, as examples, may thus use the underground structure viewing system 1000 to conduct routine inspections of various underground structures, and to record their findings for particular underground structures. In one example, a user of a mobile device 108 of the underground structure viewing system 1000 may inspect a particular valve and see, from the history of that valve, that it was recently actuated or checked by another inspector. This history information, as well as any other data inputted into the data entry display 146 or other like data entry interface for one or more underground structures, may be used to generate reports, analytics, and other forms of output.

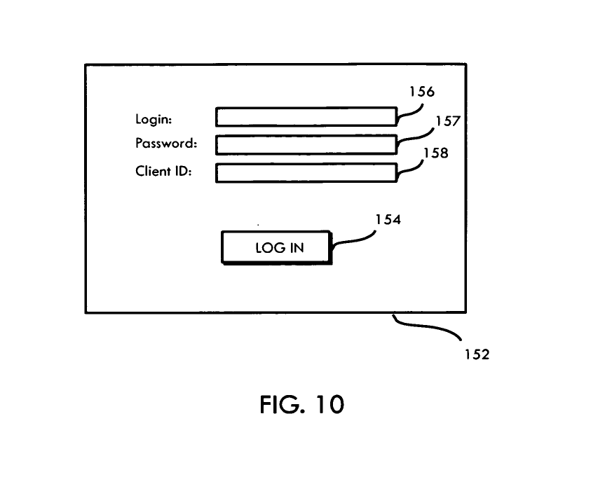

In one preferred and non-limiting embodiment of the present invention, authorization may be required to access some or all of the features of the underground structure viewing system. With reference to FIG. 10, an authorization entry display 152 is shown according to one non-limiting embodiment. The authorization entry display 152 includes text fields 156, 157, 158 for login information including login identification 156, password 157, and client identification 158. The client identification field 158 may be used to keep track of different client accounts or projects, as examples. The authorization entry display 152 also includes a log-in button 154 for submitting the inputted credentials to the host 102 or for otherwise determining authorization to use the underground structure viewing system 1000. A user's credentials may be associated with different levels of access, including full access or limited access. The credentials may provide a user with the authority to modify, add, and/or delete underground structure data, as examples, or may restrict such actions. Moreover, the credentials may identify particular users as administrators of accounts or subaccounts for other users, allowing the administrators to specify a level of access and/or authority for each user.

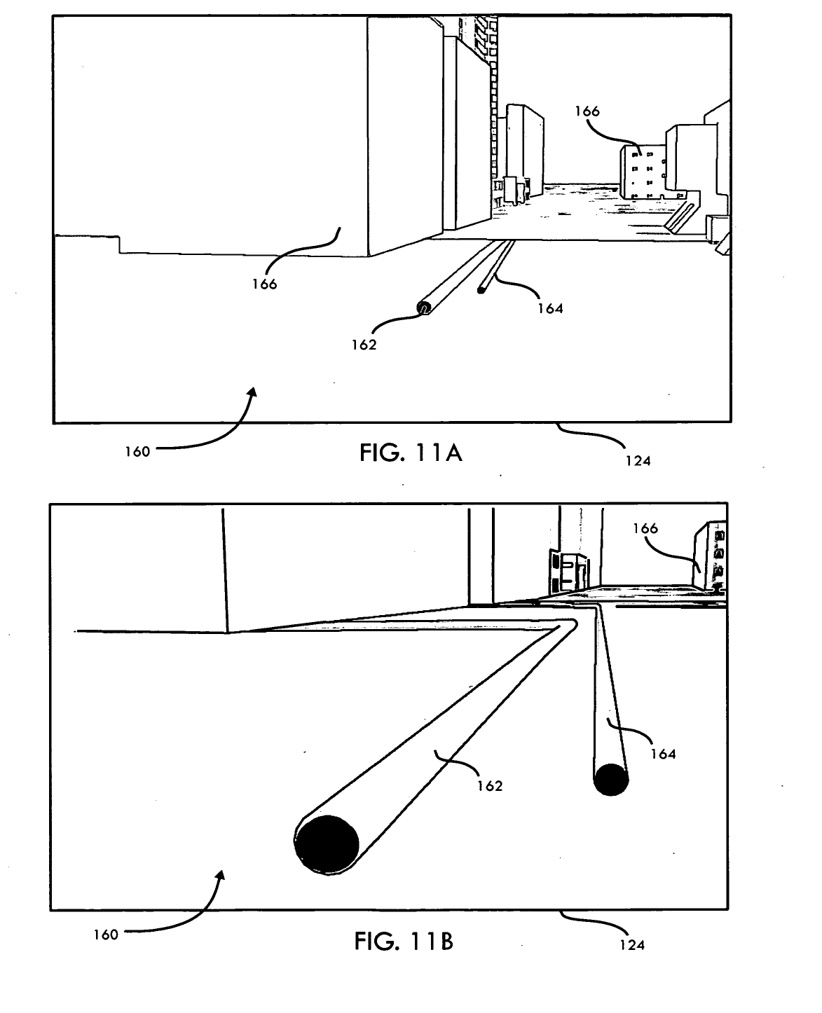

Referring to FIGS. 11A and 11B, GUIs 124 are shown in a three-dimensional mode according to one preferred and non-limiting embodiment of the present invention. A three-dimensional rendering 160 of an area and underground structures 162, 164 (as well as the surrounding or local aboveground and underground area) are displayed. The display may also include three-dimensional renderings of buildings 166 and/or other objects and geographical features. The renderings of the underground structures 162, 164 may be displayed according to the location, depth, and/or orientation of the underground structures. As a location of the mobile device 108 changes, the three-dimensional rendering 160 of the area may be updated and rendered again based on the new location. The three-dimensional rendering 160 may also be displayed based on a physical location and/or orientation of the mobile device 108. For example, the rendering 160 may be generated such that it appears that a user of the mobile device 108 is looking through the device 108. In this example, if the user tilts the mobile device 108 toward the ground, such that the mobile device 108 is substantially parallel to the ground with the display device 110 facing upward, the rendering 160 may be of any underground structures and/or other objects that are on or under the ground directly in front of the mobile device 108. The direction that the mobile device 108 is pointed in may establish a target area that affects the area represented by the rendering 160. As the orientation and/or direction of the mobile device 108 is changed, the target area may be changed and, as a result, the rendering 160. Different target areas may be associated with different underground structures, or different portions of underground structures. It will be appreciated that the three-dimensional renderings 160 of an area, underground structures 162, 164, and buildings 166 may be generated with any number of graphics libraries, application programming interfaces (API), and/or applications such as, for example, OpenGL, DirectX, AutoCAD, and/or the like. Further, the orientation of the mobile device 108 with respect to the environment can be determined using gyroscopes, accelerometers, compasses, navigational systems, orientation arrangements, and the like.

In one preferred and non-limiting embodiment of the present invention, an augmented reality mode is provided for viewing underground structures. In an augmented reality mode, the camera unit 119 of the mobile device 108 is used to display the graphical representation of the area 111 on the display 110 of the mobile device 108 such that it appears that the user is looking directly through the mobile device 108. This may be accomplished by providing streaming real-time image/video data from the camera unit 119 to the display 110 of the mobile device 108. Three-dimensional or two-dimensional renderings of underground structures 162, 164, as shown in FIGS. 11A and 11B, may be generated and overlaid on top of the streaming real-time image/video data based at least partially on a location and/or orientation of the mobile device 108 with respect to actual underground structures. In the augmented reality mode, actual real-time image/video data is combined with rendered underground structures to provide a user with clear indications and reference points of where various underground structures are located.

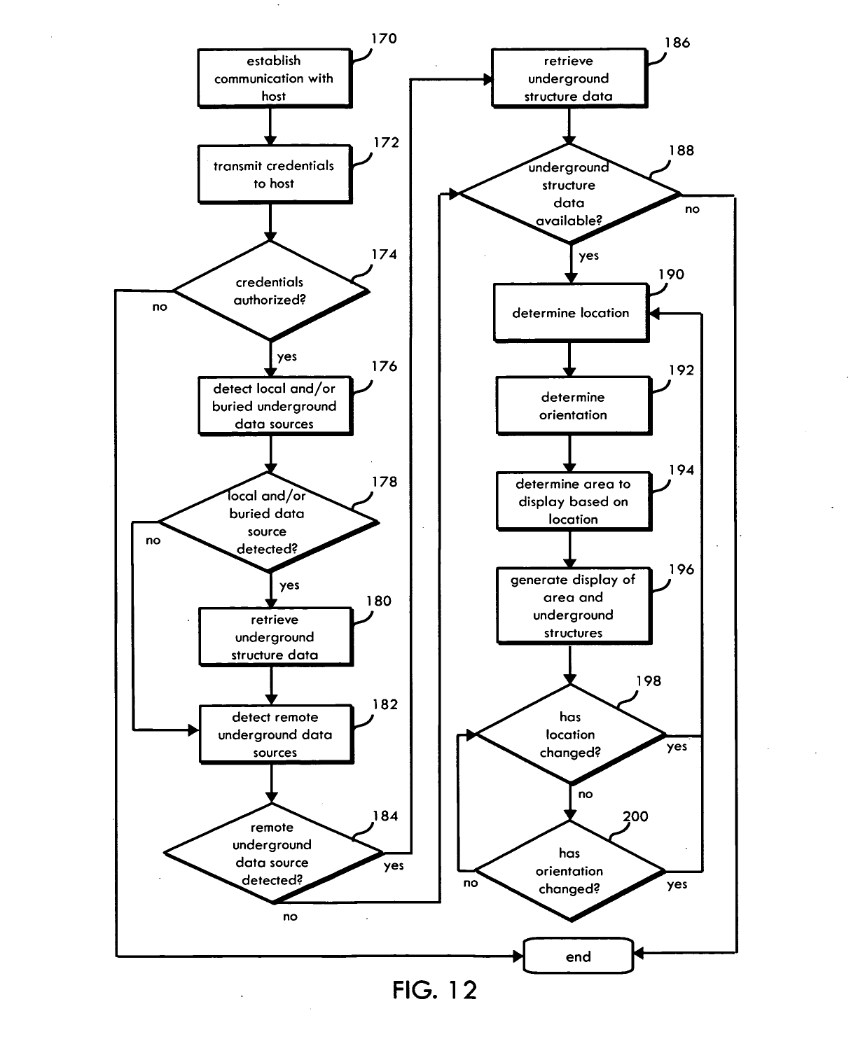

Referring to FIG. 12, a flow diagram is shown for a method of viewing underground structures according to one preferred and non-limiting embodiment of the present invention. At a first step 170, the mobile device 108 establishes communication with the host 102. At a second step 172, credential information is sent to the host 102 or is otherwise used to authenticate a user of the system. The system determines if the credentials are authorized at a third step 174 and, if they are authorized, the method detects local and/or buried underground structure data sources at step 176. Then, the system determines if there is a local data source and/or a buried data source at step 178. If a local and/or a buried data source is detected, the method proceeds to a next step 180 in which underground structure data is retrieved from the local and/or buried underground structure data source, and then to step 182 to detect remote underground structure data sources. If a local and/or buried data source is not detected at step 178, the method proceeds directly to step 182 in which the system detects one or more remote underground data sources. At step 184, a determination is made if a remote data source has been detected and, if it has, underground structure data is retrieved at step 186 from the remote data source.

With continued reference to FIG. 12, at step 188, a determination is made whether any underground structure data has been retrieved or is otherwise available from any of the local, buried, or remote data sources. If no underground structure data has been retrieved or is otherwise available, the method ends. Otherwise, the method proceeds to step 190 and a location of the mobile device 108 is determined. At a next step 192, an orientation of the mobile device 108 is determined. At step 194, an area to be displayed is determined based at least on the location of the mobile device 108. Next, at step 196, a display of an area and related underground structures is generated based at least partially on the location and/or orientation. At a next step 198, it is determined if the location of the mobile device 108 has changed. If the location has changed, the method loops back to step 190 and a new location is determined. Otherwise, at step 200, it is determined whether the orientation of the mobile device 108 has changed and, if it has, the method loops back to step 190 and a new location is determined and, at step 192, a new orientation is determined. If the orientation has not changed at step 200, the method may loop back to step 198 to check if the location of the mobile device 108 has changed and the loop may continue until at least one of the location and orientation has changed.

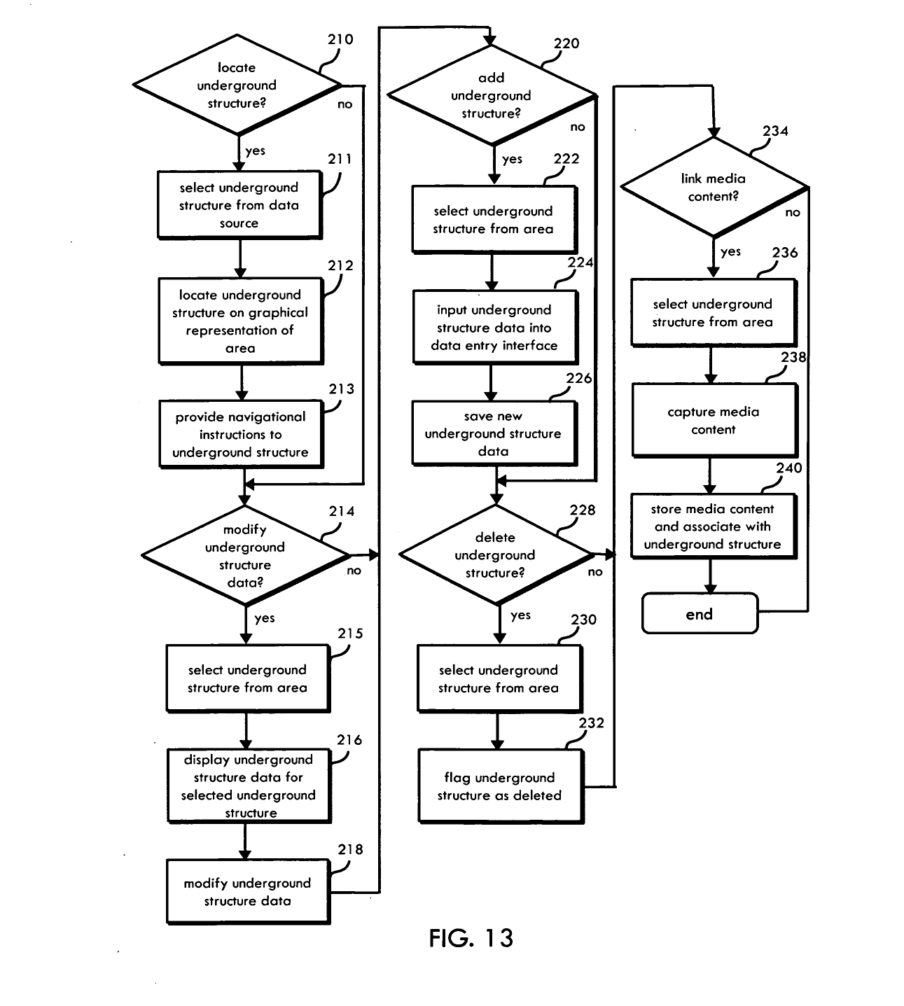

Referring to FIG. 13, a step diagram is shown for a method of locating underground structures and adding, deleting, and modifying underground structure data according to one preferred and non-limiting embodiment of the present invention. Starting at step 210, if a user of the mobile device 108 indicates a choice to locate an underground structure, the method proceeds to step 211 in which the user selects a particular underground structure, to step 212 in which the selected underground structure is located on a graphical representation of an area, and to step 213 in which navigational instructions to the selected underground structure are displayed. If the user does not choose to locate an underground structure, or after the underground structure has been located, the user may indicate a choice to modify the underground structure data for that particular underground structure at step 214. If such an indication is made, the user may select the underground structure from the displayed area at step 215 (or the underground structure selected may be the structure that was previously located), the relevant underground structure data may be displayed at step 216, and the underground structure data may be modified and saved to the relevant data source at step 218.

Still referring to FIG. 13, a user may indicate to add a new underground structure to the underground structure data source at step 220. If such an indication is made, at step 222 the underground structure is selected from the displayed area or one or more points on the displayed area are selected, at step 224 the user is presented with a data entry interface 146 to input underground structure data for the new underground structure, and at step 226 the inputted data is saved to the relevant data source. At step 228, a user may indicate an intention to delete an underground structure. If such an intention is indicated, the underground structure may be selected at step 230, and may be flagged as deleted in (or actually deleted from) the underground structure data source. At step 234, a user may indicate an intention to link media content with a particular underground structure. If media content is to be linked, the relevant underground structure may be selected at step 236, media content (e.g., image, video, audio, or document data) may be captured by the mobile device or associated device at step 238, and stored and associated with the underground structure at step 240.

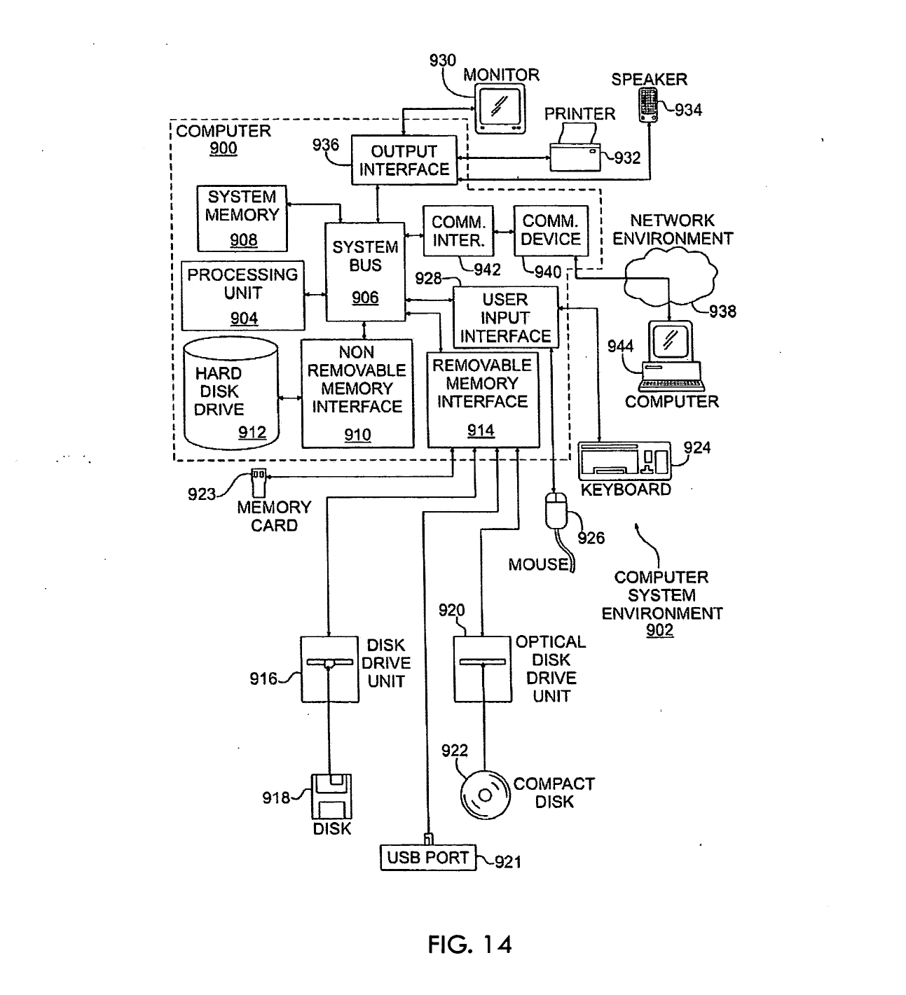

The present invention may be implemented on a variety of computing devices and systems, wherein these computing devices include the appropriate processing mechanisms and computer-readable media for storing and executing computer-readable instructions, such as programming instructions, code, and the like. As shown in FIG. 14, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 14, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 14 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure or otherwise implement the methods, processes, and transformational data manipulations discussed hereinafter in connection with the present invention. Still further, the computer 900 may be in the form of a smartphone, a tablet computer, a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Computer 944 represents one or more work stations appearing outside the local network and bidders and sellers machines. The bidders and sellers interact with computer 900, which can be an exchange system of logically integrated components including a database server and web server. In addition, secure exchange can take place through the Internet using secure www. An e-mail server can reside on system computer 900 or a component thereof. Electronic data interchanges can be transacted through networks connecting computer 900 and computer 944. Third party vendors represented by computer 944 can connect using EDI or www, but other protocols known to one skilled in the art to connect computers could be used.

The exchange system can be a typical web server running a process to respond to HTTP requests from remote browsers on computer 944. Through HTTP, the exchange system can provide the user interface graphics. It will be apparent to one skilled in the relevant art(s) that the system may utilize databases physically located on one or more computers which may or may not be the same as their respective servers. For example, programming software on computer 900 can control a database physically stored on a separate processor of the network or otherwise.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A mobile device for displaying underground structures, the mobile device comprising:
at least one processor;
at least one display device;
at least one computer-readable medium comprising program instructions that, when executed by the at least one processor, cause the mobile device to:
determine a location of the mobile device;
determine an area to be displayed based at least partially on the location of the mobile device;
identify underground structure data for the area to be displayed, the underground structure data representing a location of at least a portion of at least one underground structure; and
generate, on or with the at least one display device, a graphical representation of the area including the at least one underground structure.

2. The mobile device of claim 1, wherein the program instructions further cause the mobile device to:
determine a second location of the mobile device;
determine a second area to be displayed based at least partially on the second location of the mobile device;
identify underground structure data for the second area to be displayed, the underground structure data representing a location of at least a portion of at least one other underground structure; and
generate, on or with the at least one display device, a graphical representation of the second area including the at least one other underground structure.

3. The mobile device of claim 1, wherein the program instructions further cause the mobile device to:
generate, with the at least one display device, a selection menu comprising a plurality of options, the plurality of options including at least one of the following: an underground structure, an underground structure type, an underground structure material, an underground structure depth, an underground structure size, an underground structure pressure, an underground structure status, or any combination thereof; and
receive at least one selection from the selection menu, wherein the at least one underground structure is displayed based at least partially on the at least one selection.

4. The mobile device of claim 1, wherein the program instructions further cause the mobile device to associate media content with at least one underground structure, the media content comprising at least one of the following: a photograph, a video, a document, an audio file, or any combination thereof.

5. The mobile device of claim 1, wherein the program instructions further cause the mobile device to display instructions for navigating from the location of the mobile device to a location of a selected underground structure.

6. The mobile device of claim 5, wherein the instructions are displayed at least partially based on the underground structure data and at least one of the following: a gyroscope, an accelerometer, a camera unit, a compass, or any combination thereof.

7. The mobile device of claim 6, wherein the instructions comprise at least one arrow indicating a direction to a location of the selected underground structure.

8. The mobile device of claim 1, wherein the underground structure data is received from at least one of the following: an internal data storage device of the mobile device, an external data storage device of the mobile device, a remote underground structure database, a buried underground structure data source, or any combination thereof.

9. The mobile device of claim 1, wherein the at least one underground structure comprises at least one of the following: a vent, a pipeline, a conduit, a cable, a line, a valve, a manhole, a culvert, a fitting, a sewer, a hydrant, a meter, a catch basin, a curb inlet, a lift station, a pump station, a cleanout, a manhole, a pole, an electrical junction box, a curb box, a storage tank, or any combination thereof.

10. A computer-implemented method for displaying underground structures on a mobile device including at least one processor, the method comprising:
generating, on the mobile device, a display of an area based at least partially on a location of the mobile device;
receiving underground structure data for the location of the mobile device; and
generating, on the display of the area, at least a portion of at least one underground structure based at least partially on the location and the underground structure data.

11. The computer-implemented method of claim 10, further comprising:
generating, on the mobile device, an updated display of a second area based at least partially on a second location of the mobile device; and
receiving updated underground structure data for the second location.

12. The computer-implemented method of claim 10, further comprising:
generating, on the mobile device, a selection menu comprising a plurality of options, the plurality of options including at least one of the following: an underground structure, an underground structure type, an underground structure material, an underground structure depth, an underground structure size, an underground structure pressure, an underground structure status, or any combination thereof; and
receiving at least one selection from the selection menu, wherein the at least one underground structure is displayed based at least partially on the at least one selection.

13. The computer-implemented method of claim 10, further comprising associating media content with at least one underground structure, the media content comprising at least one of the following: a photograph, a video, a document, an audio file, or any combination thereof.

14. The computer-implemented method of claim 10, further comprising displaying instructions for navigating from the location of the mobile device to a location of a selected underground structure.

15. The computer-implemented method of claim 14, wherein the instructions are displayed at least partially based on the underground structure data and at least one of the following: a gyroscope, an accelerometer, a camera unit, a compass, or any combination thereof.

16. The computer-implemented method of claim 15, wherein the instructions comprise at least one arrow indicating a direction to a location of the selected underground structure.

17. The computer-implemented method of claim 10, wherein the underground structure data is received from at least one of the following: an internal data storage device of the mobile device, an external data storage device of the mobile device, a remote underground structure database, a buried underground structure data source, or any combination thereof.

18. The computer-implemented method of claim 10, wherein the at least one underground structure comprises at least one of the following: a vent, a pipeline, a conduit, a cable, a line, a valve, a manhole, a culvert, a fitting, a sewer, a hydrant, a meter, a catch basin, a curb inlet, a lift station, a pump station, a cleanout, a manhole, a pole, an electrical junction box, a curb box, a storage tank, or any combination thereof.

19. A system for displaying underground structures on a mobile device, the system comprising:
at least one underground structure database comprising underground structure data;
at least one server computer configured to:
receive location data from a mobile device, the location data based at least partially on a physical location of the mobile device;
transmit, to the mobile device, at least a first portion of the underground structure data based at least partially on the location data;
receive updated location data from the mobile device, the updated location data based at least partially on a second physical location of the mobile device; and
transmit, to the mobile device, at least a second portion of the underground structure data based at least partially on the updated location data.

20. The system of claim 19, further comprising at least one underground probing device configured to probe at least one underground structure and record coordinate data for the at least one underground structure, wherein the underground structure data comprises at least a portion of the recorded coordinate data.

21. The system of claim 19, wherein the at least one server computer is further configured to receive user input representing at least one of a status and an attribute of a selected underground structure.

22. The system of claim 19, wherein the at least one server computer is further configured to receive at least one user selection from a selection menu comprising a plurality of options, wherein the plurality of options comprise at least one of the following: an underground structure, an underground structure type, an underground structure material, an underground structure depth, an underground structure size, an underground structure pressure, an underground structure status, or any combination thereof.

23. The system of claim 19, wherein at least a portion of at least one of the first portion and second portion of the underground structure data is based at least partially on the at least one user selection.

24. The system of claim 19, wherein the at least one server computer is further configured to transmit, to the mobile device, data configured to display at least one alert comprising at least one of a status and an attribute of at least one underground structure.

25. The system of claim 19, wherein the at least one server computer is further configured to:
receive, from the mobile device, user input comprising modified underground structure data; and
update at least a portion of the underground structure data based at least partially on the modified underground structure data.

26. A computer-implemented method for displaying underground structures on a mobile device, the method comprising:
receiving location data from a mobile device, the location data based at least partially on a physical location of the mobile device;
transmitting, to the mobile device, at least a first portion of the underground structure data based at least partially on the location data;
receiving updated location data from the mobile device, the updated location data based at least partially on a second physical location of the mobile device; and
transmitting, to the mobile device, at least a second portion of the underground structure data based at least partially on the updated location data.

27. The computer-implemented method of claim 26, further comprising:
probing at least one underground structure with at least one underground probing device; and
recording coordinate data for the at least one underground structure, wherein the underground structure data comprises at least a portion of the recorded coordinate data.

28. The computer-implemented method of claim 26, further comprising receiving user input representing at least one of a status and an attribute of a selected underground structure.

29. The computer-implemented method of claim 26, further comprising receiving at least one user selection from a selection menu comprising a plurality of options, wherein the plurality of options comprise at least one of the following: an underground structure, an underground structure type, an underground structure material, an underground structure depth, an underground structure size, an underground structure pressure, an underground structure status, or any combination thereof.

30. The computer-implemented method of claim 26, wherein at least a portion of at least one of the first portion and second portion of the underground structure data is based at least partially on the at least one user selection.

31. The computer-implemented method of claim 26, further comprising transmitting to the mobile device, data configured to display at least one alert comprising at least one of a status and an attribute of at least one underground structure.

32. A non-transitory machine-readable medium comprising program instructions that, when executed by at least one mobile device including at least one processor, cause the mobile device to:
determine a location and an orientation of a mobile device;
generate a display on the mobile device based at least partially on the orientation and the location of the mobile device, the display comprising at least one of the following: a map, a satellite image, a camera image, a rendering, a two-dimensional rendering, a three-dimensional rendering, or any combination thereof;
receive underground structure data for the location of the mobile device from at least one of the following: a remote underground structure database, a local underground structure database, a buried underground structure data source, or any combination thereof; and
generate, in combination with the display, a visual representation of at least one underground structure based at least partially on the underground structure data.

33. The non-transitory machine-readable medium of claim 32, wherein the mobile device is further caused to:
generate an updated display of a second area based at least partially on a second location of the mobile device; and
receive updated underground structure data for the second location.

34. The non-transitory machine-readable medium of claim 32, wherein the mobile device is further caused to:
generate a selection menu comprising a plurality of options, the plurality of options including at least one of the following: an underground structure, an underground structure type, an underground structure material, an underground structure depth, an underground structure size, an underground structure pressure, an underground structure status, or any combination thereof; and
receive at least one selection from the selection menu, wherein the at least one underground structure is displayed based at least partially on the at least one selection.

35. The non-transitory machine-readable medium of claim 32, wherein the mobile device is further caused to:
receive a user input indicating a selected underground structure; and
display instructions to navigate from the location of the mobile device to a location of the selected underground structure.

36. The non-transitory machine-readable medium of claim 35, wherein the instructions are displayed at least partially based on the underground structure data and at least one of the following: a gyroscope, an accelerometer, a compass, a camera unit, or any combination thereof.
